(19) United States
(12) Patent Application Publication
(10) Pub. No.: US 2007/0061582 A1
(43) Pub. Date: Mar. 15, 2007

(54) IMAGE PROCESSING METHOD, IMAGE PROCESSING APPARATUS, AND STORAGE MEDIUM

(75) Inventors: Seiji Ohmori, Tokyo (JP); Wataru Suzuki, Tokyo (JP); Yuji Suga, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/464,891

(22) Filed: Aug. 16, 2006

(30) Foreign Application Priority Data
Sep. 9, 2005 (JP) 2005-262651

(51) Int. Cl. H04L 9/00

(52) U.S. Cl. 713/176

(57) ABSTRACT

An image processing method includes inputting a plurality of component image data, each component image data including information indicating a storage location of an electronic signature for the component image data, selecting a component image data associated with an electronic signature to be verified from the plurality of component image data, and acquiring the electronic signature associated with the selected component image data in accordance with the information indicating the storage location.

### BACKGROUND OF THE INVENTION

1. Field of the Invention

The present invention relates to a technique of generating and verifying an electronic signature of image data.

2. Description of the Related Art

In recent years, with rapid advancement and proliferation of computers and networks, a wide variety of information such as text data, image data, and audio data have come into use in the form of digital data. Deterioration does not occur with age in digital data, and thus digital data can be retained for a very long time without any deterioration. Another feature of digital data is that digital data can be easily copied, edited, and processed.

Although the feature of digital data in terms of capability of being copied, edited and processed is very useful for users, there is a need to protect digital data from being copied, edited, or processed for illegal use. Thus, security technology for digital data is becoming increasingly important.

In view of the above, in order to make it possible for a receiver of data to detect whether the received data has been altered (e.g., tampered), an electronic signature technique has been proposed. In the electronic signature technique, additional data for detecting alteration (e.g., tampering) is attached to digital data, and the additional data is verified to determine whether the digital data has been altered. The electronic signature technique is useful not only to detect alteration but also to detect spoofing or denial on a network.

In recent years, a wide variety of electronic documents have become available. In many electronic documents, a plurality of document components (such as image data and text data) are included in a single electronic document. Japanese Patent Laid-Open No. 2002-333835 discloses a technique of applying an electronic signature to an electronic document. In this technique, contents of component data to which electronic signatures were applied are displayed together with signer name and a result of verification of electronic signatures.

However, in a case in which electronic signatures are individually applied to a plurality of respective document components as is the case in the technique disclosed in Japanese Patent Laid-Open No. 2002-333835, it is difficult to efficiently verify image data including electronic signatures applied to component images. That is, for image data including a plurality of document components to which electronic signatures were separately applied, it is not easy to detect, from document components, the correspondence between document components and electronic signatures, and thus it may be necessary to perform verification for all document components.

### SUMMARY OF THE INVENTION

In view of the above, an embodiment of the present invention provides a technique to sufficiently verify an electronic signature associated with an arbitrary component image included in given image data.

More particularly, according to an embodiment of the present invention, an image processing method includes inputting a plurality of component image data, each component image data including information indicating a storage location of an electronic signature for the component image data, selecting a component image data associated with an electronic signature to be verified from the plurality of component image data, and acquiring the electronic signature associated with the selected component image data in accordance with the information indicating the storage location.

According to an aspect of the present invention, an embodiment is directed to generating image data in a form that allows it to sufficiently verify an electronic signature associated with a selected component image included in the image data.

More particularly, according to an embodiment of the present invention, an image processing method includes inputting image data having a plurality of component images, generating an electronic signature for a component image, and adding information indicating a storage location of the electronic signature to the component image.

According to an embodiment of the present invention, an image processing apparatus includes an input unit, a selection unit and an electronic signal acquisition unit. The input unit is configured to input a plurality of component image data. Each component image data includes information indicating a storage location of an electronic signature for the component image data. The selection unit is configured to select a component image data associated with an electronic signature to be verified from the plurality of component image data. The electronic signature acquisition unit is configured to acquire the electronic signature associated with the selected component image data in accordance with the information indicating the storage location.

According to an embodiment of the present invention, an image processing apparatus includes an input unit to input image data including a plurality of component images, an electronic signature generation unit to generate an electronic signature for a component image, and an addition unit to add information indicating a storage location of the electronic signature to the component image.

Further features of the present invention will become apparent from the following description of exemplary embodiments with reference to the attached drawings. It is noted that the references to “an” or “one” embodiment of this disclosure are not necessarily directed to the same embodiment, and such references mean at least one.

### BRIEF DESCRIPTION OF THE DRAWINGS

FIG. 1 is a schematic diagram showing an example of a basic configuration of a system according to an embodiment of the present invention.

FIG. 2 is a block diagram showing an example of a functional configuration of a system according to an embodiment of the present invention.

FIG. 3 is a diagram showing an example of an internal hardware configuration of an electronic document producing apparatus and an electronic document processing apparatus.

FIG. 4 is a block diagram showing a functional configuration of a system according to an embodiment of the present invention.

FIG. 5 is a flow chart showing a process performed by a structured data generator according to an embodiment of the present invention.

FIGS. 6A and 6B show an example of an electronic data.

FIGS. 7A and 7B show an example of a data structure of an electronic document generated by an electronic document producing apparatus according to an embodiment of the present invention.

FIG. 8 is a flow chart showing an electronic signature generation process according to an embodiment of the present invention.

FIG. 9 shows an example of information processed by an electronic document producing apparatus according to an embodiment of the present invention.

FIG. 10 shows an example of information obtained by processing the information shown in FIG. 9 by the electronic document producing apparatus according to an embodiment of the present invention.

FIG. 11 shows an example of a data structure of an electronic document generated by an electronic document producing apparatus according to an embodiment of the present invention.

FIG. 12 shows an example of table information included in an electronic document generated by an electronic document producing apparatus according to an embodiment of the present invention.

FIG. 13 shows an example of an electronic document display application window according to an embodiment of the present invention.

FIG. 14 shows an example of an electronic document displayed by an electronic document display application program according to an embodiment of the present invention.

FIG. 15 shows an example of an electronic document displayed by an electronic document display application program according to an embodiment of the present invention.

FIG. 16 shows an example of an electronic document displayed by an electronic document display application program according to an embodiment of the present invention.

FIG. 17 shows an example of an electronic document displayed by an electronic document display application program according to an embodiment of the present invention.

FIG. 18 shows an example of an electronic document displayed by an electronic document display application program according to an embodiment of the present invention.

FIG. 19 shows an example of an electronic document displayed by an electronic document display application program according to an embodiment of the present invention.

FIG. 20 shows an example of an electronic document displayed by an electronic document display application program according to an embodiment of the present invention.

FIG. 21 shows an example of an electronic document display application window according to an embodiment of the present invention.

FIG. 22 shows a signature generation process and a signature verification process according to an embodiment of the present invention.

FIG. 23 is a block diagram showing a functional configuration of a system according to an embodiment of the present invention.

FIG. 24 is a block diagram showing an example of an internal hardware configuration of an electronic document producing apparatus according to an embodiment of the present invention.

FIG. 25 is a diagram showing an example of a user interface configuration of an operation unit shown in FIG. 24 according to an embodiment of the present invention.

FIG. 26 is a flow chart showing a verification process according to an embodiment of the present invention.

### DESCRIPTION OF THE EMBODIMENTS

### First Exemplary Embodiment

FIG. 1 is a schematic diagram showing an example of a configuration of a system according to an embodiment of the present invention. Reference numeral 101 denotes a scanner adapted to convert a paper document into image data. Reference numeral 102 denotes a computer used to generate an electronic document. Reference numeral 103 denotes a computer used to verify an electronic signature applied to an electronic document and also used to generate print data. Reference numeral 104 denotes a printer used to print an image in accordance with print data. These devices, that is, the scanner 101, the computer 102, the computer 103, and the printer 104, are connected to a network 105. Although in the example shown in FIG. 1, the system includes four devices, the system may be configured differently. For example, instead of the scanner 101 and the computer 102, a single device (such as a high-performance scanner or copier) may be used which has all functions similar to those provided separately by the scanner 101 and the computer 102. Similarly, instead of the computer 103 and the printer 104, a single device (such as a high-performance printer or copier) may be used which has all functions provided by the computer 103 and the printer 104.

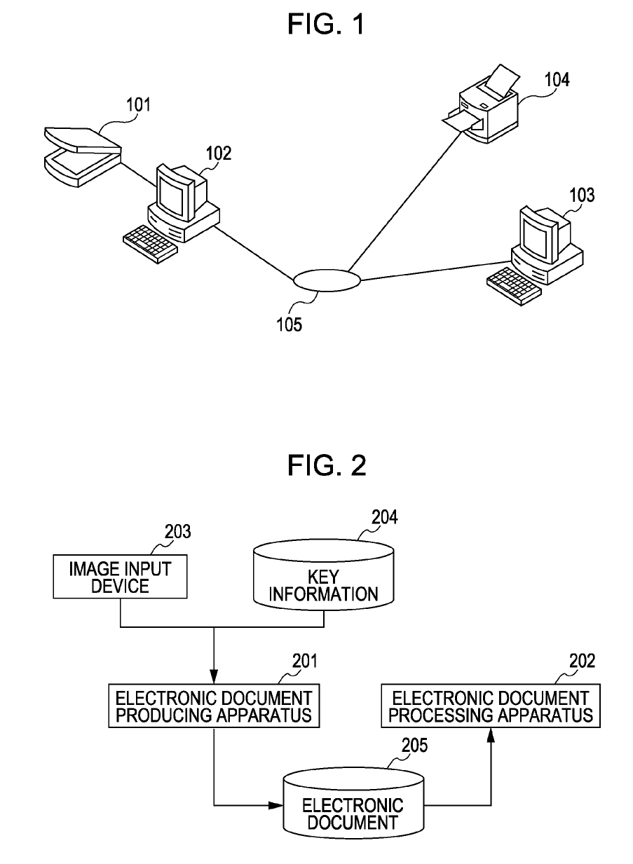

FIG. 2 is a block diagram showing an example of a functional configuration of the system according to present embodiment. In FIG. 2, image data is input using an image input device 203. Key information 204 is an encryption key used in production of an electronic signature. An information processing apparatus serving as an electronic document producing apparatus 201 produces an electronic document 205 by applying an electronic signature to the input image data in accordance with the key information 204. The produced electronic document 205 is sent via a network to an electronic document processing apparatus 202 serving as a verification apparatus. The electronic document processing apparatus 202 verifies the received electronic document. The electronic document processing apparatus 202 also processes, edits, and prints the electronic document as required.

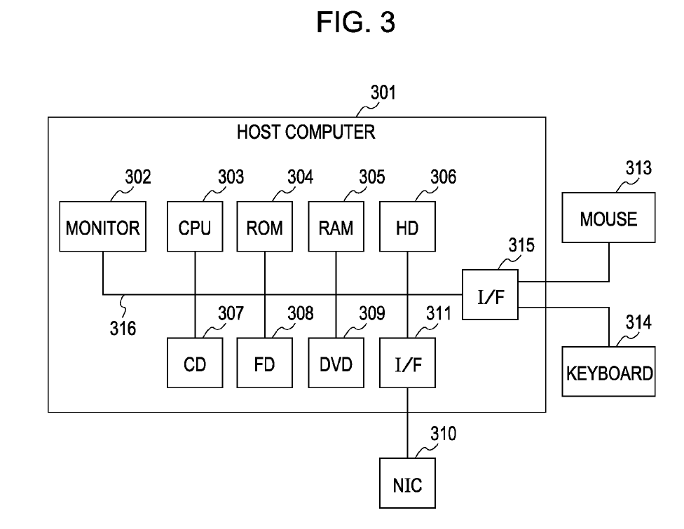

FIG. 3 is a diagram showing a basic configuration of a host computer 301 and also showing peripheral devices connected to the host computer 301. An electronic document producing apparatus 201 and an electronic document processing apparatus 202, which will be described later, may also be configured in a similar manner to the host computer 301. As for the host computer 301, a widely used type of personal computer may be employed. In FIG. 3, reference numeral 302 denotes a monitor adapted to display various kinds of information output from the host computer 301.

Reference numeral 303 denotes a CPU adapted to control various parts of the host computer 301 and also adapted to execute programs stored in a RAM 305. Reference numeral 304 denotes a ROM in which a BIOS (Basic Input Output System) and a boot program are stored. Reference numeral 305 denotes a RAM for temporarily storing image data and a program executed by the CPU 303. An OS (Operating System) and programs executed by the CPU 303 to perform various processes described later are loaded in this RAM 305.

Reference numeral 306 denotes a hard disk (HD) used to store the OS and the programs transferred into the RAM. The hard disk 306 is also used by the host computer 301 to store and read image data during the operation. Reference numeral 307 denotes a CD-ROM drive adapted to read data from a CD-ROM (or read and write data to or from CD-R), which is one of external storage media. Reference numeral 308 denotes an FD drive adapted to read and write data from or from an FD (floppy disk) in a similar manner to the CD-ROM drive 307.

Reference numeral 309 denotes a DVD-ROM (DVD-RAM) drive adapted to read data from a DVD-ROM or a DVD-RAM and write data to a DVD-RAM in a similar manner to the CD-ROM drive 307. When an image processing program is stored on the CD-ROM, the FD, the DVD-ROM, or the like, the program is first installed into the HD 306 and loaded from the HD 306 into the RAM 305 as required.

Reference numeral 311 denotes an interface (I/F) for connecting the host computer 301 to a network interface card (NIC 310) for connection to a network such as the Internet. The host computer 301 transmits or receives data to or from the Internet via the interface 311. Reference numeral 315 denotes an interface (I/F) for connecting a mouse 313 and a keyboard 314 to the host computer 301. Via this interface 315, various kinds of commands are input from the mouse 313 or the keyboard 314 to the CPU 303.

The host computer 301 is capable of storing image data or the like on the HD 306, the CD 307, the FD 308, or the DVD 309, and is capable of reading the image data from them and displaying the image on the monitor 302.

It is allowed to transmit the image data over the Internet or the like via the NIC 310. A user is allowed to input various commands using the mouse 313 or the keyboard 314. In the inside of the host computer 301, various blocks (described later) are connected to one another via a bus 316 so that various kinds of data can be sent and received among the blocks.

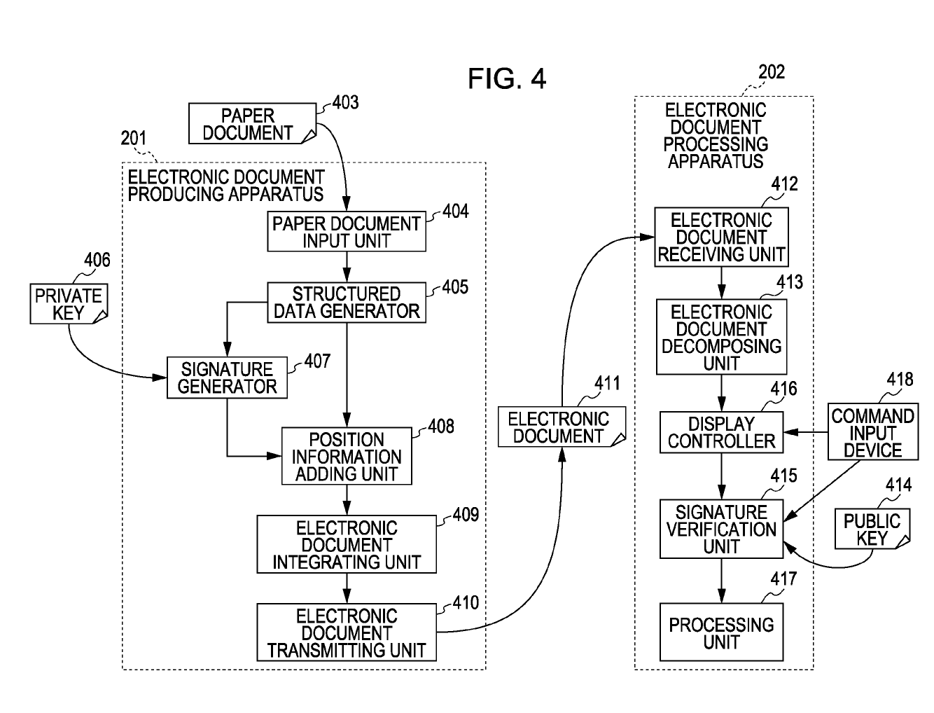

FIG. 4 is a block diagram showing a functional configuration of the system according to the present embodiment. As shown in FIG. 4, the system according to the present embodiment includes an electronic document producing apparatus 201 and an electronic document processing apparatus 202.

The electronic document producing apparatus 201 includes the following units. A paper document input unit 404 is a unit for inputting a paper document 403. A structured data generator 405 analyzes the paper document and generates structured data.

A signature generator 407 generates an electronic signature based on the structured data and a private key 406. A position information adding unit 408 relates location information of the structured data to the electronic signature generated by the signature generator 407. An electronic document integrating unit 409 integrates the structured data and the electronic signature into a single electronic document 411. An electronic document transmitting unit 410 transmits the electronic document 411 to an electronic document processing apparatus 202.

The electronic document processing apparatus 202 includes the following units. An electronic document receiving unit 412 receives the electronic document 411. An electronic document decomposing unit 413 decomposes the integrated electronic document 411 into the structured data and the electronic signature.

A display controller 416 displays the decomposed structured data in the form of an image. A command input device 418 is a device such as a mouse adapted to input information to the display unit 416 or the signature verification unit 415. A signature verification unit 415 verifies the electronic signature based on the structured data, the electronic signature, and the public key 414. An processing unit 417 performs an operation such as modification, editing, printing, on the decomposed electronic document.

Now, the details of each functional block are described below.

The paper document input unit 404 inputs a paper document using the scanner 101 or the like based on a suitable photoelectric conversion technique.

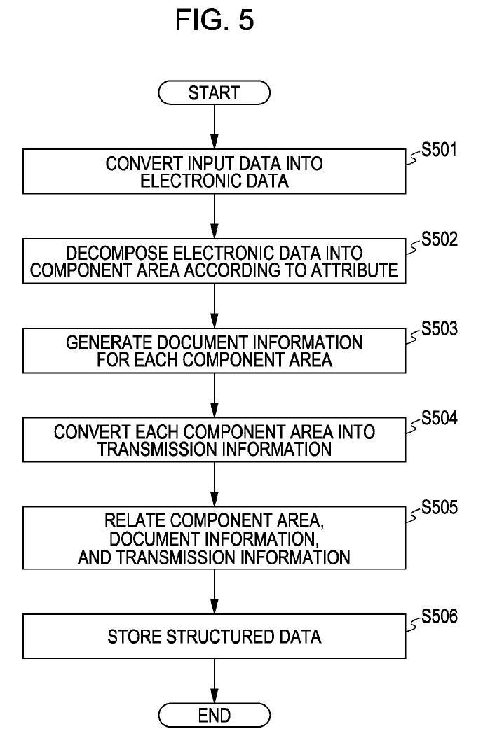

The details of the structured data generator 405 are described with reference to FIG. 5.

FIG. 5 is a flow chart showing a processing flow of a process performed by the structured data generator 405 according to the present embodiment.

In step S501, the data supplied from the paper document input unit 404 is converted into electronic data.

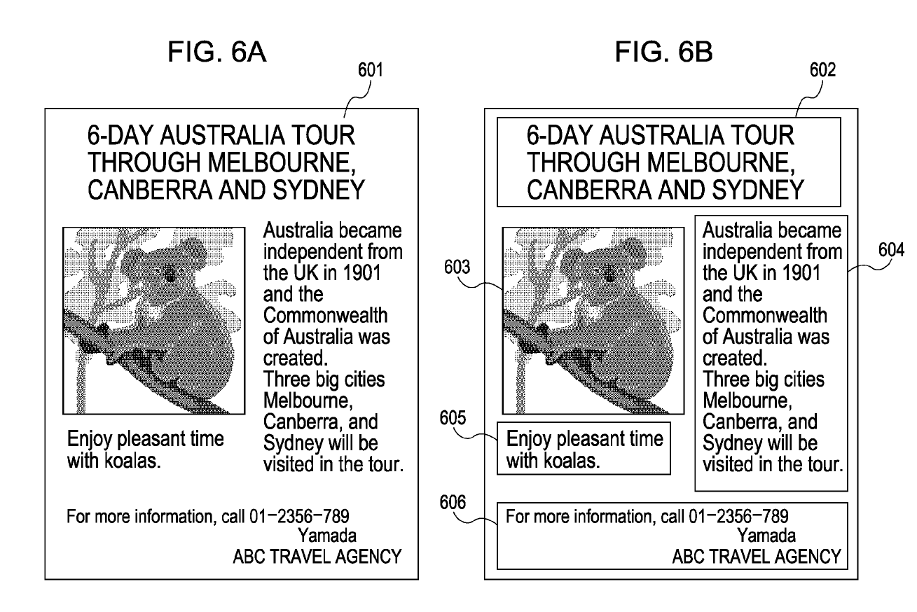

FIG. 6A shows an example of electronic data obtained in step S501.

In step S502, one page of image is divided into a plurality of component areas (component images) according to the attribute of each component area. The component area refers to an area in which one or more images having the same attribute are continuously distributed. The term “attribute” is used herein to describe image types, such as text, a photographic image, a table, or a graphical image. Dividing of a given image into component areas can be accomplished using a suitable technique. For example, sets of black pixels or white pixels are detected from a document image, and areas of particular attributes such as a text area, a photographic image area, a table area, a frame area, a line area, etc. are extracted based on features of the sets of pixels, such as the shape, the size, the manner in which pixels are clustered in the respective sets of pixels, etc.

FIG. 6B shows an example of a result of division into component areas according to determination of attributes based on extracted features. In this example shown in FIG. 6B, component areas 602, 604, 605 and 606 are respectively extracted as text areas, and a component area 603 is extracted as a color photographic area.

In step S503, document information is generated for each component area obtained in the previous step. The term “document information” is used herein to describe a set of information which may include attribute information, layout information indicating page position coordinates or the like, a character code string (when a component area is a text area), and information indicating a document logical structure such as paragraphs, titles, etc.

In step S504, each component area obtained in the previous step is converted into transmission information. The transmission information refers to information described in a form that allows the information to be rendered. Specific examples of transmission information include a resolution-variable raster image, a vector image, a monochrome image, and a color image, and a file size or the like of such an image. When a component area is a text area, the transmission information may include text data obtained as a result of character recognition, information indicating positions of respective characters, font data, information indicating likelihood of characters obtained by character recognition, etc.

In the example shown in FIG. 6B, the text areas 602, 604, 605, are 606 converted into vector data, while the color photographic image area 603 is converted into color raster data.

In step S505, the component areas obtained in step S502, the document information generated in step S503, and the transmission information obtained in step S504 are related to one another. In an embodiment, the relation is described in the form of a tree structure.

In step S506, a set of data generated via the previous steps is stored as the structured data. The structured data may be stored in any format as long as the tree structure can be represented. In an embodiment, the structuring document is stored in the XML format.

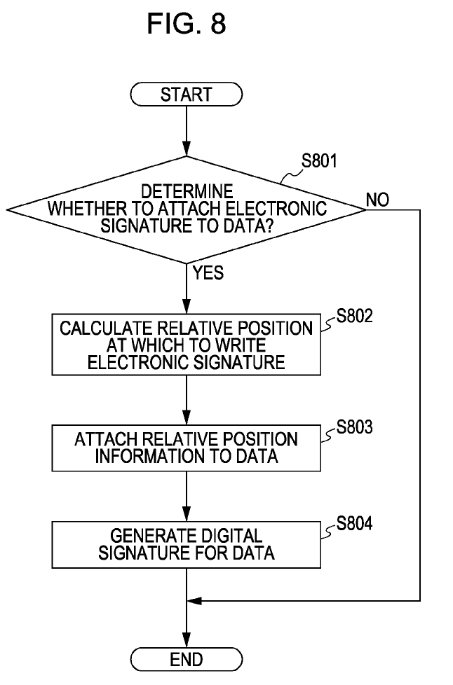

Now, the details of the signature generator 407 shown in FIG. 4 are described with reference to FIG. 8.

The signature generator 407 generates an electronic signature associated with the transmission information or document information of the structured data generated via the steps described above. In the generation of the electronic signature associated with the structured data by the signature generator 407, an electronic signature generation technique is used.

FIG. 8 is a flow chart showing a flow of processing performed by the signature generation unit 407 according to an embodiment of the present invention.

In step S801, a determination is made as to whether to add an electronic signature to data of interest, such as transmission information or document information. If the determination is that an electronic signature is to be attached (“Yes” in step S801), the process proceeds to step S802. However, the determination is that application of an electronic signature is not required (“No” in step S801), the process is ended.

In step S802, a relative position at which to store the electronic signature is calculated. The relative position is expressed by the number of bytes as counted starting from the start position of electronic document generated by the electronic document integrating unit 409. The signature generator 407 calculates the relative position of internal data of the electronic document generated by the electronic document integrating unit 409. Although in the present embodiment, the address with respect to the start position is used to express the relative position, the reference position is not limited to the start position, but an arbitrary position in the electronic document generated by the electronic document integrating unit 409 may be used as the reference position. In a case in which the given electronic document is a text document, the number of characters as counted with respect to a reference position may be used as the position information instead of the byte address.

In step S803, the relative position calculated in the previous step is embedded in the area to be signed, as relative position information indicating the position where the electronic signature is stored.

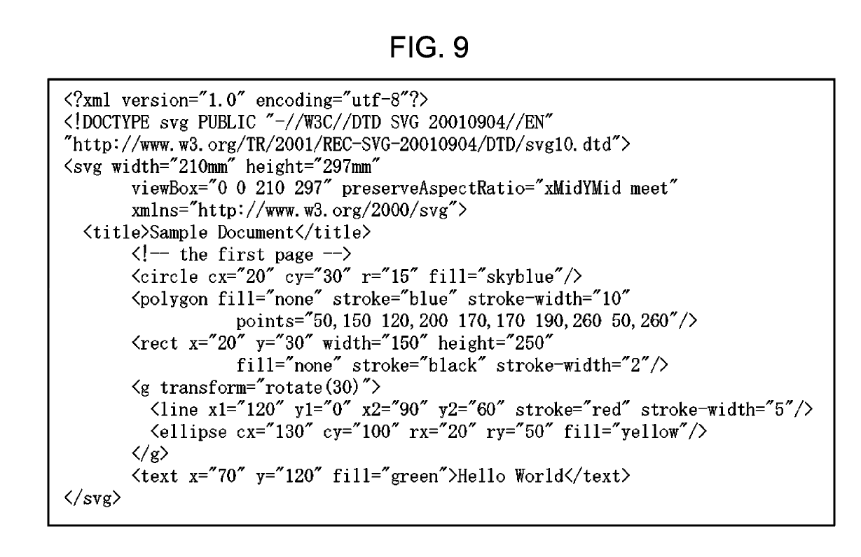

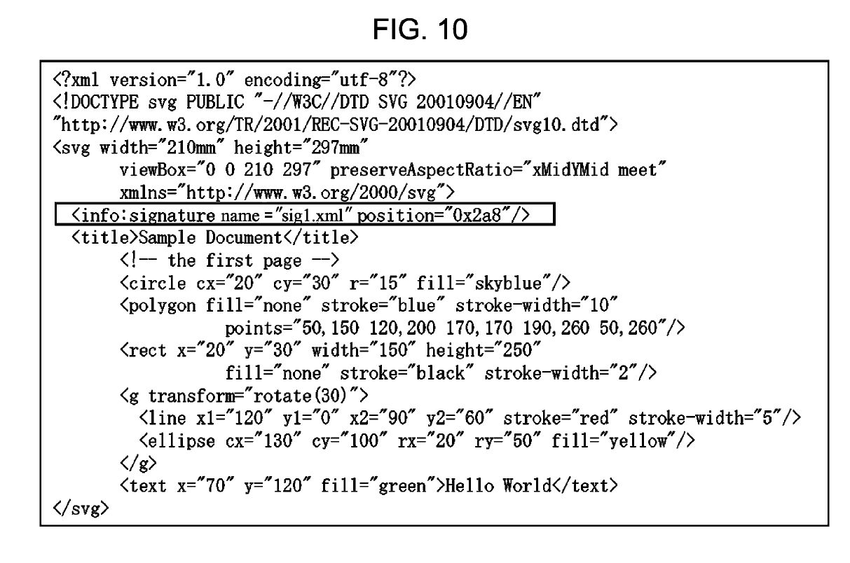

FIG. 9 shows an example of transmission information in the XML format to which an electronic signature is to be applied. FIG. 10 shows XML data obtained by embedding, in step S803, the position information indicating the position at which the electronic signature is stored in the transmission information shown in FIG. 9. In the example shown in FIG. 10, a character string 1001 “<info: signature name=“sig1.xml” position=“0x2a8”/>” is added.

This character string 1001 indicates that the electronic signature has a data name “sig.xml” and is stored at the relative position “0x2a8”. In step S804, an electronic signature for the data to be signed is generated.

FIG. 22 shows a signature generation process and a signature verification process. The electronic signature is generated by use of public key encryption using a hash function. More specifically, when a private key 2206 and a public key 2211 are given, a sender first performs a hash process 2202 on input data 2201 and calculates a digest value 2203 with a fixed data length.

An electronic signature 2205 is then generated by performing a conversion process 2204 on the fixed length data using a private key 2206. The resultant electronic signature 2205 is transmitted together with the input data 2201 to a receiver.

At the receiving end, a verification process 2212 is performed as follows. That is, data obtained by performing a conversion (decoding) process using the public key 2211 on the electronic signature 2210 is compared with data 2209 obtained by performing a hash process 2208 on the input data 2207. If the comparison result 2213 indicates that these two data are identical, it is determined that the input data 2207 has not been altered (e.g., tampered). On the other hand, if the result 2213 indicates that the two data are not identical, it is determined that the input data 2207 has been altered.

The signature generation process is described in further detail below with reference to the flow chart shown in FIG. 22. The signature generator 407 calculates the digest value 2203 with the fixed data length by performing the hash process 2202 on the transmission information given as the input data 2201. The signature generator 407 then generates the electronic signature 2205 by performing the conversion process 2204 using the private key 406 shown in FIG. 4 as the private key 2206.

The electronic signature may be generated for each of all pieces of the transmission information included in the structured data or only for a particular one or more of the transmission information. Although in the present embodiment, the electronic signature is described in the XML format, the electronic signature may be described in another format.

In the above-described process performed by the signature generator 307, the private key 406 may be selected by the signer of the electronic document from a plurality of private keys stored in advance in the storage unit (the HD 306 or the like) provided as one of hardware units in the electronic document producing apparatus 201. A storage medium such as an IC in which the private key is stored may be connected to the electronic document producing apparatus 201, and the private key may be read from this storage medium.

The process described above makes it possible to easily refer to the electronic signature described in the signed data.

If step S804 is performed at an earlier time than step S803, then the signed area is changed when the electronic signature is generated, and thus it is determined that alteration (e.g., tampering) has been performed. Therefore, in one embodiment, the processing order between S803 and S804 is not allowed to change.

When no electronic signature is attached to transmission information, that is, when there is no position information corresponding to the transmission information, it is not necessary to embed the position information indicating the position of the electronic signature. Alternatively, in this case, a character string may be embedded to indicate that there is no electronic signature.

In the example described above, the position information is embedded in the XML document. In a case in which an area to be signed is JPEG data, similar data may be embedded in a proper area, which allows a character string to be embedded, in a header of the JPEG data.

In the embodiment described above, the signature generator 407 acquires the position information and embeds the acquired position information in the data to be signed. Alternatively, the signature generator 407 may only acquire the position information, and the electronic document integrating unit 409 may generate an electronic document in which the position information is placed adjacent to the signed data.

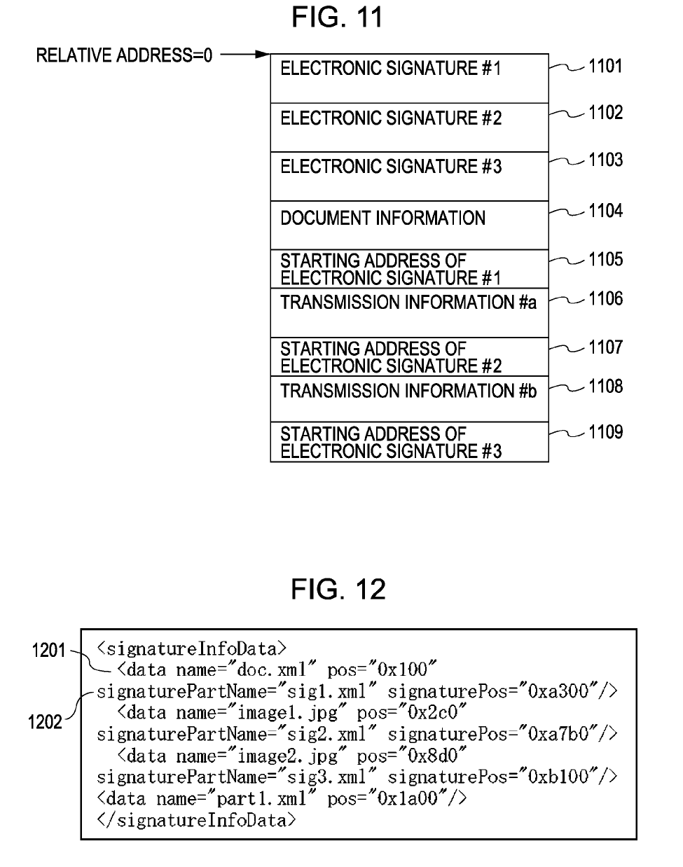

In this case, data of the electronic document generated by the electronic document integrating unit 409 may be stored in memory at addresses, for example, as shown in FIG. 11. In FIG. 11, an electronic signature #1 (1101) is a signature for the document information (1104). Similarly, an electronic signature #2 (1102) and an electronic signature #3 (1103) are respectively signatures for the transmission information #a (1106) and the transmission information #b (1108).

As shown in FIG. 11, the start address 1105 of the electronic signature #1 is set at a memory address adjacent to the document information 1104. Similarly, the start addresses 1107 and 1109 of the respective electronic signatures #2 and #3 are set at memory addresses respectively adjacent to the transmission information 1106 #a (1106) and the transmission information #b (1108).

In a case in which no electronic signature is applied to transmission information, that is, in a case in which there is no electronic signature corresponding to transmission information, no electronic signature start address is described. In this case, a predefined value (for example, −1) indicating that there is no electronic signature may be placed.

Alternatively, a table indicating the correspondence between signed areas and position information of electronic signatures may be produced, and the table may be incorporated into an electronic document generated by the electronic document integrating unit 409. FIG. 12 shows an example of such a table described in the XML format so as to indicate the correspondence between signed areas and position information of electronic signatures.

In FIG. 12, “doc.xml” and “0x100” described in a row denoted by reference numeral 1201 respectively indicate the data name of a signed area and the address of the signed area in the electronic document.

In a row denoted by a reference numeral 1202, “sig1.xml” indicates the data name of an electronic signature, and “0xa300” indicates the address of the electronic signature. Such a table may be preferably produced by the electronic document integrating unit 409. Alternatively, the table may be produced by the electronic document decomposing unit 413.

In a case in which the electronic signature generation process is not performed for transmission information, that is, in a case in which there is no electronic signature corresponding to transmission information, no correspondence information associated with this transmission information is described in the table. Alternatively, information may be described in the table to indicate that there is no electronic signature associated with this transmission information.

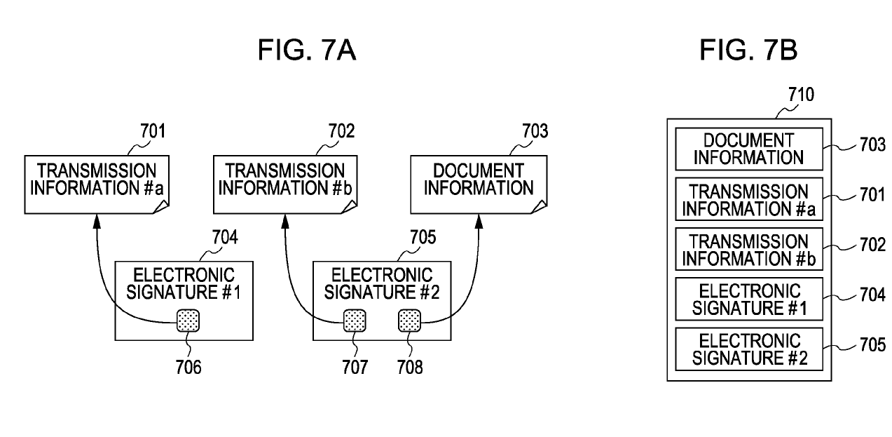

Now, the position information adding unit 408 is described below with reference to FIG. 7A.

The position information adding unit 408 adds the position information indicating the position of transmission information or document information to the electronic signature generated by the signature generator 407 to relate the structured data, the electronic signature, and the document information. FIG. 7A shows an example of an electronic document processed by the position information adding unit 408.

Reference numerals 701 and 702 denote, transmission information of the structured data generated by the structured data generator, and reference numeral 703 denotes document information.

Reference numerals 704 and 705 denote electronic signatures generated by the signature generator. In the example shown in FIG. 7A, the position information 706 pointing to the address of the transmission information #a (701) signed with the electronic signature 704 is incorporated in the electronic signature 704. The electronic signature 705 is an electronic signature for a combination of the transmission information #b (702) and the document information 703. Therefore, the position information 707 indicating the position of the transmission information #b (702) and the position information 708 indicating the position of the document information 703 are incorporated as position information in the electronic signature 705. Thus, to verify the electronic signature 705 of the document information 703, the signature verification unit (described later) first refers to the position information of the electronic signature 705 embedded in the document information 703. The position information 707 of the transmission information #b (702) embedded in the electronic signature 705 is then referred to. Thus, the transmission information #b (702) necessary to verify the electronic signature 705 is first obtained, and then the electronic signature 705 is verified.

It is not necessarily needed that electronic signatures correspond one-to-one to signed data. For example, the position information 707 and the position information 708 respectively pointing to the transmission information #b (702) and the document information 703, which are signed with the electronic signature 705, may be embedded in the electronic signature 705. In the case in which position information pointing to an electronic signature is embedded in signed data by the signature generator 407, both the electronic signature and the signed data have position information pointing to each other. That is, in this case, the electronic signature has position information pointing to the signed data, and the signed data has position information pointing to the electronic signature, and thus each can refer to position information pointing to each other. In order to make it possible to perform electronic signature verification in a case in which a single electronic signature is assigned to a combination of a plurality of signed data, such as the combination of the transmission information #b (702) and the document information 703, the electronic signature needs to have position information pointing to the signed data. However, when electronic signatures correspond one-to-one to signed data, it is possible to verify electronic signatures even if electronic signatures do not have position information pointing to the signed data.

The electronic document integrating unit 409 and the electronic document decomposing unit 413 are described with reference to FIGS. 7A and 7B.

The information of structured data 701, 702, and 703 generated by the structured data generator 405 and the electronic signatures 704 and 705 generated by the signature generator 407 are a set of XML data or binary image data. The electronic document integrating unit 409 generates an electronic document by integrating the individual data into a single document. The integration may be performed using a suitable technique such as an archiving technique (for example, using a zip format).

The electronic document decomposing unit 413 decomposes the integrated data 710 into individual data, that is, structured data and electronic signatures such as those shown in FIG. 7A.

Now, the display controller 416 and the command input device 418 are described.

The display controller 416 displays on a display the electronic document decomposed by the electronic document decomposing unit 413, and controls the displayed electronic document in accordance with a command input via the command input device 418.

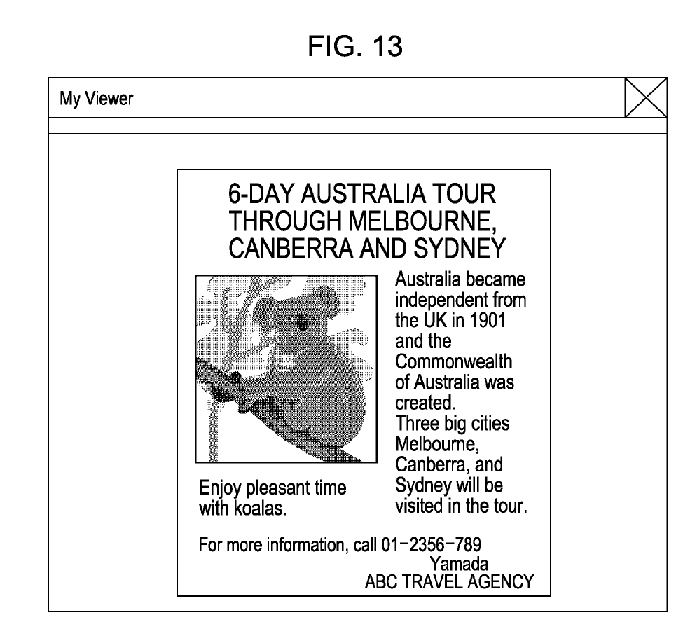

FIG. 13 shows an example of an electronic document display application window displayed on the display connected to the electronic document processing apparatus 202. The electronic document display application is an application software program to display electronic documents generated by the electronic document producing apparatus 201, and the displayed electronic document is controlled in accordance with the command input device 418 such as a mouse or a keyboard.

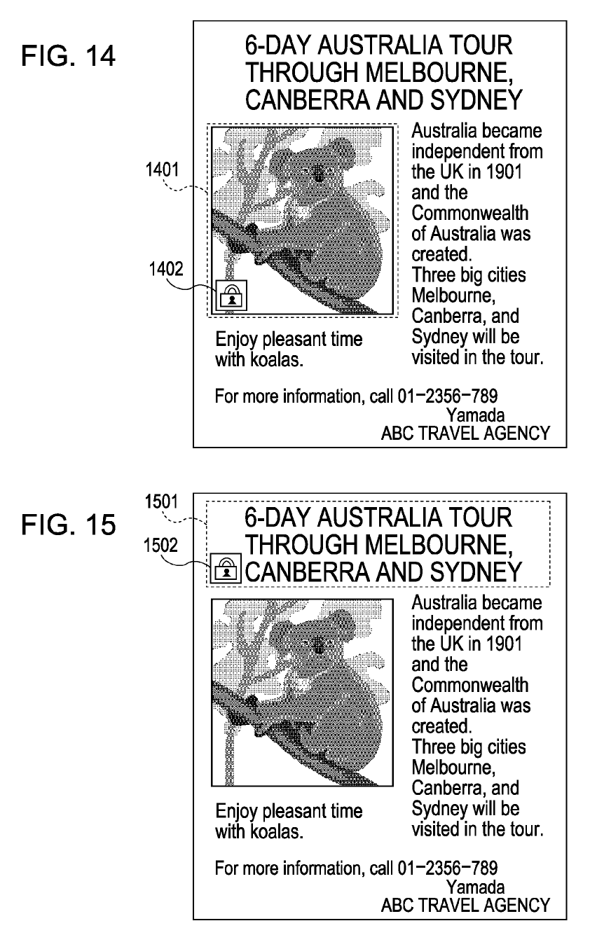

FIG. 14 shows an example of an electronic document in which a component area pointed to by the mouse has an electronic signature, that is, the transmission information pointed to by the mouse is a signed area. As shown in FIG. 14, when a mouse pointer is placed within the component area 1401, an icon 1402 is displayed in a lower left area of the component area 1401 to indicate that there is an electronic signature assigned to the component area 1401. Note that the area in which the icon 1402 is displayed does not necessarily need to be located at the lower left position, and the size of the icon 1402 does not necessarily need to be fixed. The type, color, and size of the icon 1402 may be changed depending on the degree of importance of the signed area. A specific icon may be assigned to each signer.

The determination as to whether there is an electronic signature can be made by referring to relative position information embedded, by the signature generator 407, in the transmission information. In the case in which there is a table indicating the correspondence between the signed data and the position information pointing to electronic signatures, the determination as to whether there is an electronic signature may be made by referring to the table. A broken line 1401 indicating the boundary of the component area does not necessarily need to be displayed on the screen.

FIG. 15 shows another example of an electronic document in which transmission information pointed to by the mouse has an electronic signature. In this example shown in FIG. 15, transmission information in a text data area at the top of the electronic document has an electronic signature assigned thereto. That is, when a mouse pointer is placed within the component area 1501, an icon 1502 is displayed in a lower left area of the component area 1501 to indicate that there is an electronic signature assigned to the component area 1501.

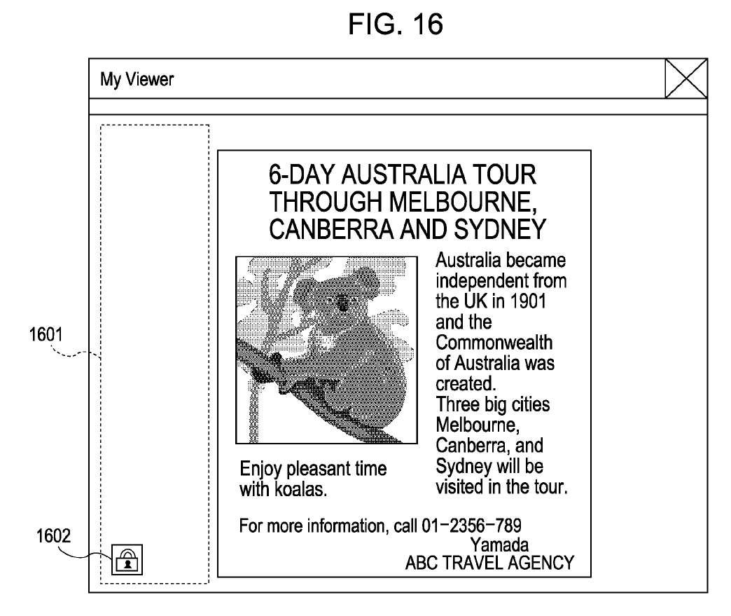

In an example shown in FIG. 16, there is an electronic signature assigned to transmission information which is not displayed on the screen. Examples of transmission information which are not shown on the screen include metadata, a print ticket, font data, information indicating the relationship between data, and thumbnail image data which is not displayed by the present application. When there is an electronic signature assigned to non-displayed data, of the mouse pointer is moved into an area 1601 on the left-hand side of the displayed document area, an icon 1602 is displayed in a lower left area of the application window to indicate that there is an electronic signature.

Now, the signature verification unit 415 and the processing unit 417 are described.

When the icon 1402, 1502, or 1602 indicating that there is an electronic signature is clicked using the mouse, the signature verification unit 415 verifies the electronic signature assigned to the signed area and displays a verification result. Referring to FIG. 22, a signature verification process is described. If signed transmission information #a (701) in the electronic document 710 shown in FIG. 7B is given as input data 2207, a hash process 2208 is performed on the input data 2207 to determine a digest value 2209 with a fixed data length.

The obtained digest value 2209 is compared with an electronic signature 2210 decoded using a public key 2211 to determine whether they are identical to each other. Note that it is assumed that the public key information has been stored in advance in the electronic document processing apparatus 202.

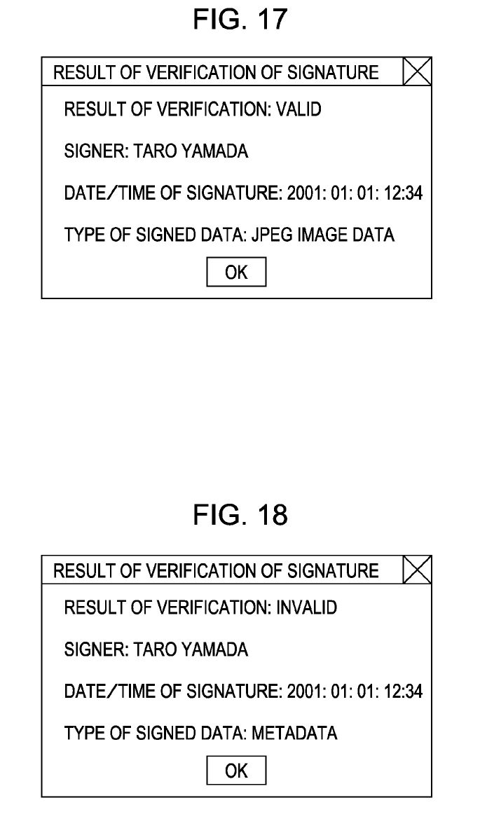

FIGS. 17 and 18 show examples of windows which are displayed when the icon 1402, 1502, or 1602 indicating that there is an electronic signature is clicked using the mouse. If mouse clicking is performed, the electronic signature assigned to the signed area is verified and a verification result is displayed.

The window shown in FIG. 17 is displayed when the verification result indicates that the electronic signature is valid. As shown in FIG. 17, in addition to the verification result, a signer name, date/time of signature, and the type of signed data are also displayed.

The window shown in FIG. 18 is displayed when the verification result indicates that the electronic signature is invalid. When the electronic signature is determined to be invalid, there is a possibility that the signed data has been tampered with. Therefore, a message “Data has been tampered with” may be displayed. As shown in FIG. 18, in addition to the verification result, a signer name, date/time of signature, and the type of signed data are also displayed. Note that displayed items are not limited to those. Only the verification result may be displayed.

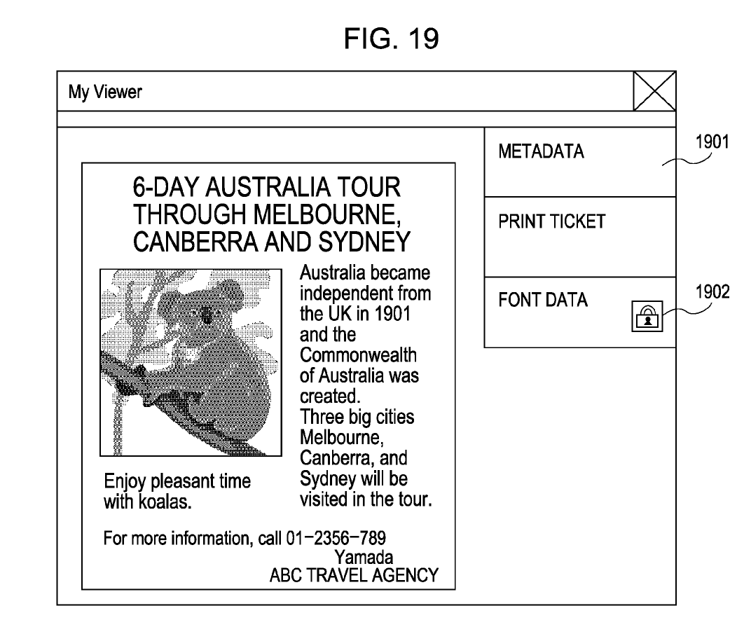

In the present embodiment, when there is an electronic signature generated for non-displayed data, displaying on the screen is performed in the manner shown in FIG. 16. Alternatively, as shown in FIG. 19, a data name list 1901 of non-displayed data may be displayed in the form of text data. When a text data area is pointed to by a mouser pointer, an icon 1902 may be displayed to indicate that there is an electronic signature.

In the embodiment described above, an icon is displayed to indicate that there is an electronic signature. Instead of displaying an icon, the whole area of a component area may be highlighted in a reverse mode or in a colored mode to indicate that there is an electronic signature. In addition to displaying for notification, a warning sound, a beep sound, a sound effect, or the like may be emitted. Alternatively, only a sound may be emitted without providing displaying for notification.

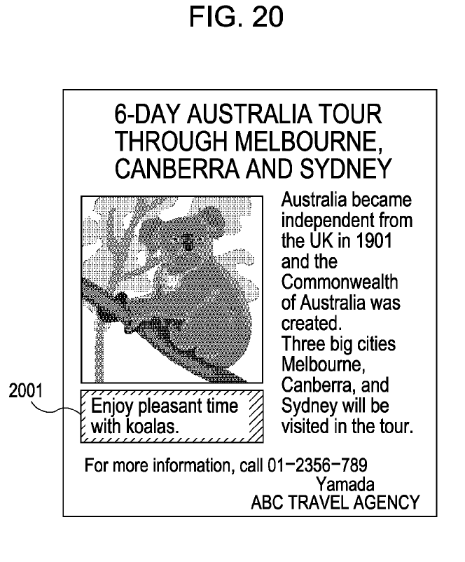

The result of verification of an electronic signature may be displayed not when an icon is clicked but when any part of a component area is clicked. FIG. 20 shows an example in which a component area is shaded with oblique lines 2001 to indicate that there is an electronic signature.

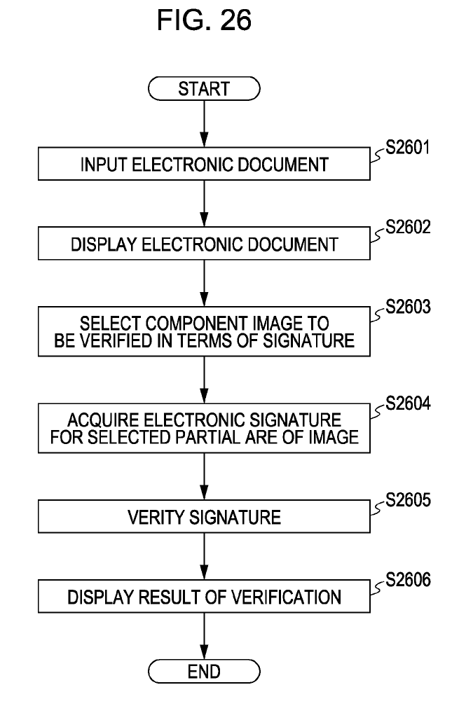

Referring to FIG. 26, a verification process, according to an embodiment of the present invention, is described below.

In step S2601, the electronic document receiving unit 412 receives an electronic document. In step S2602, the electronic document decomposing unit 413 decomposes the received electronic document and displays the resultant electronic document. In step S2603, a signed area is selected from the displayed electronic document by using the command input device 418 to specify an electronic signature to be verified. In step S2604, information indicating a storage location of the electronic signature included in the signed data is acquired, and the electronic signature to be verified is acquired. In step S2605, the signature verification unit 415 verifies the acquired electronic signature. In step S2606, a result of the verification is displayed.

In the embodiment described above, the mouse is used to select transmission information. Alternatively, transmission information may be selected using cursor keys on the keyboard. A list of transmission information may be displayed as a menu of the application and transmission information may be selected from the list.

As described above, according to the embodiment described above, when electronic signatures are separately attached to a plurality of respective components of an electronic document, an electronic signature to be verified can be efficiently selected and verified.

### Second Exemplary Embodiment

Now, a second embodiment is explained. In this second embodiment, the electronic document producing apparatus 201 is configured so as to further include a command input unit adapted to authenticate a signer when the electronic document producing apparatus 201 generates an electronic signature. This command input unit is also adapted to allow the signer to specify a component area to be signed with an electronic signature.

In the present embodiment, a system configuration, a functional configuration of the system, and an internal hardware configuration of an electronic document processing apparatus 202 are similar to those shown in FIGS. 1 and 3.

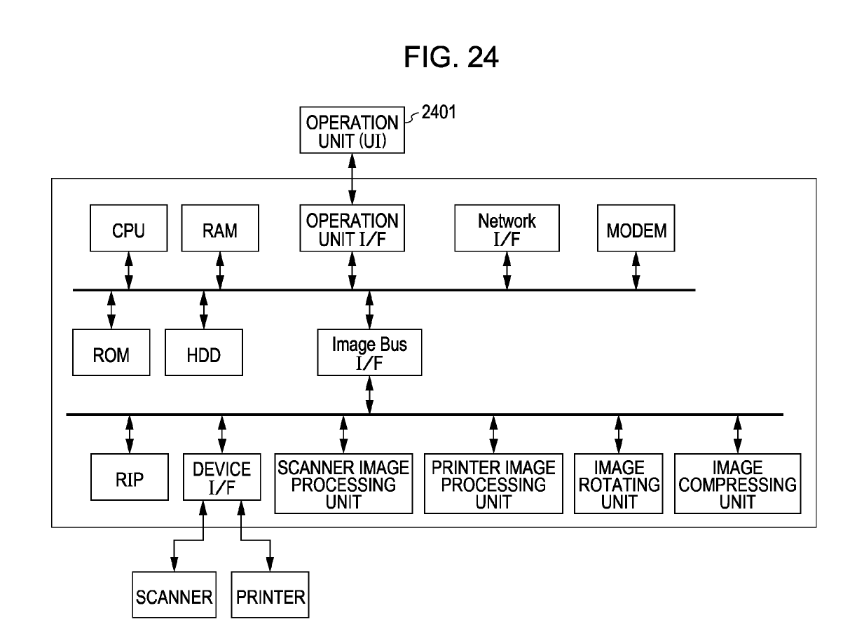

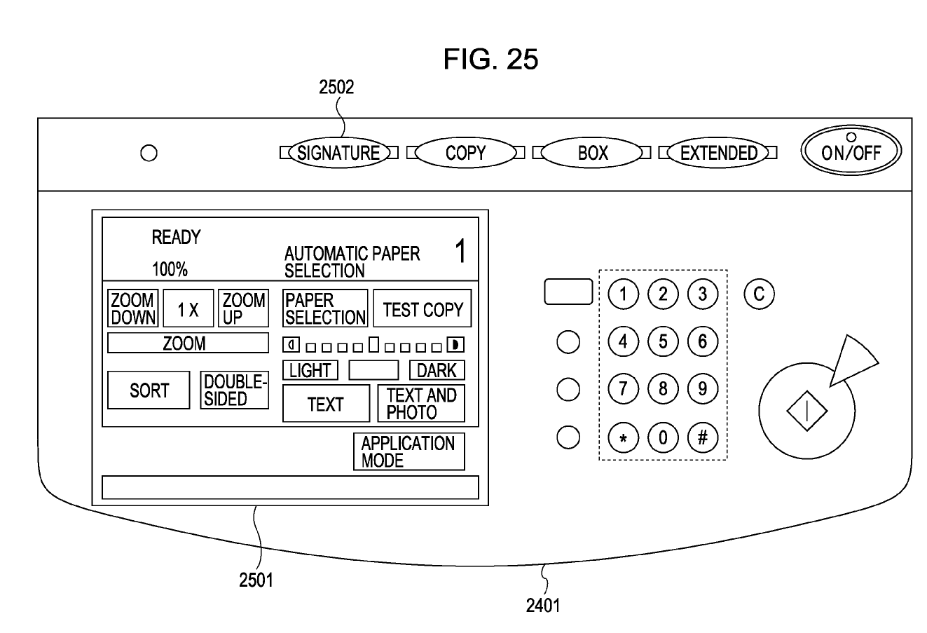

FIG. 24 shows an internal hardware configuration of the electronic document producing apparatus 201 according to an embodiment of the present invention. An operation unit 2401 is a unit for performing authentication of a signer and for selecting a component area to which to add an electronic signature. FIG. 25 shows an example of a user interface configuration of the operation unit 2401 of the electronic document producing apparatus 201 according to an embodiment of the present invention.

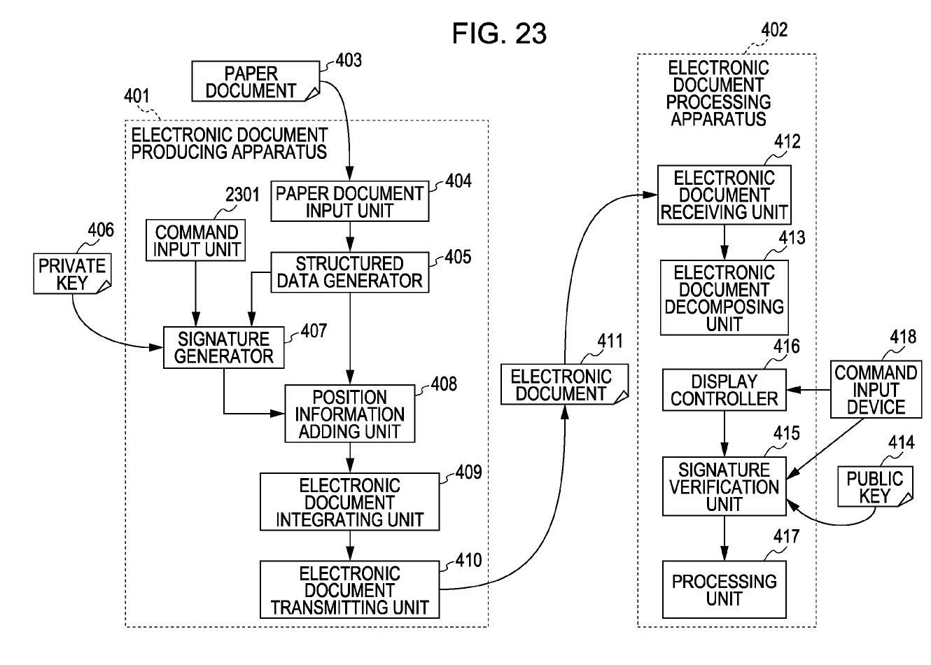

FIG. 23 is a block diagram showing a functional configuration of the present embodiment. A command input unit 2301 is a unit for authenticating a signer and for allowing the signer to select a component area in an input electronic document to be signed with an electronic signature. Information indicating the component area specified by the signer is supplied to the signature generator. The other functional blocks are similar to those according to the first embodiment described above, and a further explanation thereof is omitted.

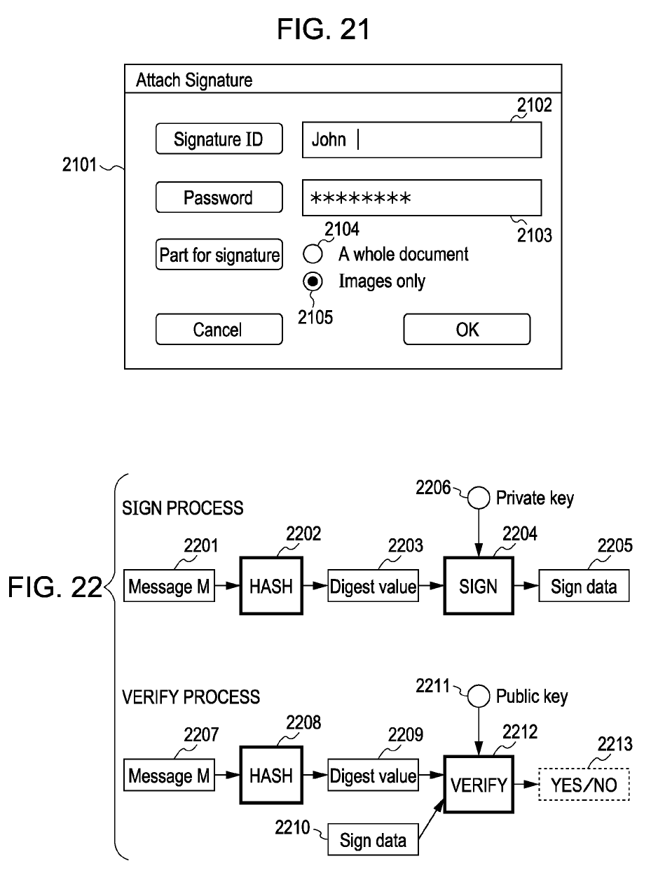

FIG. 21 shows an example of an electronic document producing application window displayed on an operation screen of the electronic document producing apparatus 201. This window is displayed on the screen 2501 (shown in FIG. 25) when a button 2502 on an operation unit 2401 is pressed. The button 2502 may be displayed on the screen 2501.

The electronic document producing apparatus 201 generates an electronic document in accordance with information input by the signer via the application window shown in FIG. 21.

Thereafter, a transmission function is selected from one or more functions displayed on the operation screen 2101 of the electronic document producing apparatus 201, 401, and at least one destination is determined. As the destination, an external device may be specified which is connected to the electronic document producing apparatus 201, 401 via a LAN or the like. The destination may be selected from external devices registered in the electronic document producing apparatus 201, 401.

In the present embodiment, it is assumed by way of example that an input electronic document is processed and the resultant electronic document is transmitted. However, alternatively, the electronic document producing apparatus 201 may have a storage adapted to store one or more electronic documents and may process an arbitrary electronic document stored therein. The format of the data to be transmitted is then determined.

The input electronic document may be directly transmitted as image data or may be transmitted in the form of an integrated data. Finally, an electronic signature to be attached to the data to be transmitted is generated. The signature generation process according to the present embodiment is similar to that according to the first embodiment described above with reference to FIG. 22.

On the user interface screen 2101 (shown in FIG. 21), at least one data necessary to generate an electronic signature is input in an input box such as a signer name ID input box 2102 or an password input box 2103. Note that data necessary to generate an electronic signature are not limited to the signer name ID and the password. A part of the input electronic document to be signed with the electronic signature is then selected. In the present example, when a radio button 2104 with a button name “A whole document” is selected, one electronic signature for the electronic document is generated. When a radio button 2105 with a button name “Images only” is selected, electronic signatures for respective images of the electronic document are generated.

The electronic document producing apparatus 201, 401 according to the present embodiment is capable of producing an electronic document in the form shown in FIG. 11, as with the electronic document producing apparatus according to the first embodiment. However, the electronic document producing apparatus 201 according to the present embodiment is different from that according to the first embodiment in that the form of the produced electronic document changes depending on whether the radio button 2104 or the radio button 2105 is selected. In a case in which the radio button 2104 is selected, only one electronic signature is generated. On the other hand, when the radio button 2105 is selected, as many electronic signatures as there are image component areas in data are generated.

When the radio button 2105 is selected, the transmission information #a (1106) shown in FIG. 11 must be image information, and the electronic signature #1 (1101) must be an electronic signature for this image information. On the other hand, when the radio button 2104 is selected, one electronic signature for an electronic document as a whole is generated. Thus, it is possible to rather easily refer to the address positions of the electronic signature and the data to be signed. Therefore, it is not necessarily needed to embed the position information pointing to the start address 1105 of the electronic signature #1 shown in FIG. 11.

Instead of using radio buttons, a list of all document data or image data included in the input electronic document may be displayed on the user interface screen 2101 so as to allow at least one of document data or image data to be selected using check boxes or the like.

When the input electronic document includes a plurality of pages, an electronic signature may be generated for a specified page or for a specified set of pages.

Alternatively, thumbnail images of respective pages may be displayed on the user interface screen 2101 so as to allow at least one of the thumbnail images to be selected. If one or more thumbnail images are selected, one or more electronic signatures may be correspondingly generated.

Alternatively, a preview image of the input electronic document may be displayed on the user interface screen 2101 so as to allow at least one data such as text data, image data, or outline data to be selected. As for text data, the selection may be made in units of paragraphs or characters.

Alternatively, data (such as font data, thumbnail images, signature information indicating the signer's name, and document data) associated with the input electronic document may be displayed in the form of a list or icons so as to allow at least one of them to be selected.

When a plurality of data to be signed are selected, one electronic signature may be generated for each selected data, or one electronic signature may be generated for the selected data as a whole.

Finally, the input electronic document and the electronic signature(s) generated for the selected data are integrated in accordance with the setting specified by the signer via the window shown in FIG. 21, and the resultant integrated data is transmitted to the destination. In the present embodiment, the transmission is performed using SMB (Server Message Block) as a transmission protocol. Alternatively, other transmission protocols such as FTP (File Transfer Protocol) or HTTP (Hyper Text Transfer Protocol) may be used. The integrated data may be transmitted as attached data of an electronic mail. At the destination, an electronic document processing apparatus 202 similar to that according to the first embodiment described above is used.

According to the first or second embodiment described above, when electronic signatures are separately assigned to a plurality of components of an electronic document, it is possible to efficiently specify an arbitrary electronic signature and verify the specified electronic signature. Conversely, it is possible to produce image data with one or more electronic signatures in a form that allows it to select an arbitrary component image and verify an electronic signature associated with the selected component image in an efficient manner.

### Other Exemplary Embodiments

The present invention is not limited to the apparatus and the methods according to the embodiments described above. For example, a software program code may be supplied to a computer (a CPU or an MPU) disposed in the system or the apparatus described above, and the computer disposed in the system or the apparatus may control various devices in accordance with the software program code thereby achieving the embodiments described above. Note that such a system or an apparatus falls within the scope of the present invention.

In this case, it should be understood that the software program code implements the functions of the embodiments of the invention. Thus, the program code and means for supplying the program code to the computer, such as a storage medium on which the program code is stored, also fall within the scope of the present invention.

Specific examples of storage media for the above purpose include a floppy (registered trademark) disk, a hard disk, an optical disk, a magneto-optical disk, a CD-ROM, a magnetic tape, a nonvolatile memory card, and a ROM.

The computer may control various devices according to the supplied program code so as to achieve one or more functions of the embodiments described above. One or more functions of the embodiments described above may be achieved by executing the above-described program code on the computer in cooperation with an OS (Operating System) and/or one or more application software programs running on the computer. In this case, the program code also falls within the scope of the present invention.

In accordance with the supplied program code, a part or all of the process may be executed by a CPU or the like provided on an expansion board disposed in the computer or an expansion unit connected to the computer thereby realizing one or more functions of the embodiments described above. Also in this case, the program code and the computer system fall within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-262651 filed Sep. 9, 2005, which is hereby incorporated by reference herein in its entirety.

What is claimed is:

1. A method comprising:
inputting a plurality of component image data, each component image data including information indicating a storage location of an electronic signature for the component image data;
selecting a component image data associated with an electronic signature to be verified from the plurality of component image data; and
acquiring the electronic signature associated with the selected component image data in accordance with the information indicating the storage location.

2. The method according to claim 1, further comprising verifying the acquired electronic signature.

3. The method according to claim 1, wherein
the acquiring the electronic signature includes acquiring information indicating whether there is an electronic signature associated with the selected component image data in accordance with the information indicating the storage location,
and wherein the image processing method further comprises notifying of presence or absence of the electronic signature.

4. The method according to claim 1, wherein the acquiring the electronic signature includes referring to a table indicating the correspondence between the component image data and information indicating the storage locations of the component image data and acquiring the selected component image data in accordance with the table.

5. A method comprising:
inputting image data including a plurality of component images;
generating an electronic signature for an component image; and
adding information indicating a storage location of the electronic signature to the component image.

6. An image processing apparatus comprising:
an input unit to input a plurality of component image data, each component image data including information indicating a storage location of an electronic signature for the component image data;
a selection unit to select a component image data associated with an electronic signature to be verified from the plurality of component image data; and
an electronic signature acquisition unit to acquire the electronic signature associated with the selected component image data in accordance with the information indicating the storage location.

7. The image processing apparatus according to claim 6, further comprising an electronic signature verification unit to verify the electronic signature acquired by the electronic signature acquisition unit.

8. The image processing apparatus according to claim 6, wherein
the electronic signature acquisition unit is adapted to acquire information indicating whether there is an electronic signature associated with the selected component image data in accordance with the information indicating the storage location,
and wherein the image processing apparatus further comprises a notification unit to notify of the presence or absence of the electronic signature.

9. The image processing apparatus according to claim 6, wherein the electronic signature acquisition unit is adapted to refer to a table indicating the correspondence between the component image data and information indicating the storage locations of the component image data and acquire the selected component image data in accordance with the table.

10. An image processing apparatus comprising:
an input unit to input image data including a plurality of component images;
an electronic signature generation unit to generate an electronic signature for an component image; and
an addition unit to add information indicating a storage location of the electronic signature to the component image.

11. A computer-readable storage medium storing instructions which, when executed by a computer, causes the computer to perform operations comprising:
inputting a plurality of component image data, each component image data including information indicating a storage location of an electronic signature for the component image data;
selecting a component image data associated with an electronic signature to be verified from the plurality of component image data; and
acquiring the electronic signature associated with the selected component image data in accordance with the information indicating the storage location.

12. A computer-readable storage medium storing instructions which, when executed by a computer, causes the computer to perform operations comprising:
inputting image data including a plurality of component images;
generating an electronic signature for an component image; and
adding information indicating a storage location of the electronic signature to the component image.
